(19) United States
(12) Patent Application Publication
(10) Pub. No.: US 2004/0090874 A1
(43) Pub. Date: May 13, 2004

(54) Apparatus and method for effective reduction of a laser beam spot size

(76) Inventors: Kunjithapatham Balasubramanian, Orlando, FL (US); Masud Mansuripur, Tucson, AZ (US)

Correspondence Address: DISCOVISION ASSOCIATES, INTELLECTUAL PROPERTY DEVELOPMENT, 2355 MAIN STREET, SUITE 200, IRVINE, CA, 92614, US

(21) Appl. No.: 10/448,242

(22) Filed: May 29, 2003

Related U.S. Application Data
(60) Provisional application No. 60/425,123, filed on Nov. 8, 2002.

(51) Int. Cl. G11B 11/00; G11B 7/135

(52) U.S. Cl. 369/13.29; 369/112.23; 369/112.17

(57) ABSTRACT

The present invention includes a method and apparatus for reducing the effective spot size of a laser beam by selectively polarizing different regions of a light beam. By suitably dividing a beam into a plurality of regions and suitably changing the polarization of the regions in different directions, certain regions with opposite polarization cancel each other out, thereby effectively eliminating these regions from analysis by the detector. When focusing onto a high density optical disk, adjacent tracks do not see the canceled, circularly-polarized portions of the beam, but instead, only see the smaller, plane-polarized portion in the center of the beam. When reading from a high density optical disk, detectors using a known differential detection scheme similarly do not see the canceled, circularly-polarized portions of the beam, but instead, only see the smaller, plane-polarized portion in the center of the beam.

### CROSS REFERENCE TO RELATED APPLICATIONS

This patent application claims priority under 35 U.S.C. § 119(e) to U.S. Provisional Patent Application Serial No. 60/425,123, filed on Nov. 8, 2002, for AN APPARATUS AND METHOD FOR EFFECTIVE REDUCTION OF A LASER BEAM SPOT SIZE, the entirety of which is hereby incorporated by reference.

### FIELD OF THE INVENTION

The present invention is related, generally, to a method and apparatus for reducing the effective spot size of a laser beam, and more particularly, to altering the polarization within each of a plurality of regions, thereby effectively canceling certain regions.

### BACKGROUND OF THE INVENTION

As a result of, inter alia, the increased use of multimedia computers, the demand for higher density storage in optical media is increasing. The capacity of optical media (i.e., optical disks and/or the like), which is typically based on the density of the information on the optical media, has substantially increased in recent years and exponential growth in the capacity of optical media is planned in the next few years. As an example of the density increase, the 4× capacity generation of magneto-optical media commonly has a capacity of about 2.6 GB, and the more recently developed 8× capacity generation commonly has a capacity of about 5.2 GB.

When increasing the capacity of an optical disk, the separation of the spiral tracks (each track comprised of a groove between two lands) typically formed on the surface of the optical disk is substantially reduced such that the individual track lines are typically less than 1 urn apart from each other. Numerous marks (also known as domains), the size of which are determined by the length of a binary representation of a data field, are commonly recorded in the grooves between the track lines. Due to the decreased distance between adjacent tracks on the high-density optical disk, the formation of a mark substantially in a groove between two adjacent track lines often becomes increasingly difficult.

To write a mark within a track or to increase the number of marks on an optical disk, a sufficiently small mark is typically required. Shorter wavelength lasers and higher numerical aperture lenses for the reading and writing devices typically determine the beam spot size, and consequently, the size of each mark. Thus, to decrease the size of the marks, a high power semi-conductor red laser (typically 685 nm) is most often utilized when writing the data marks onto the optical disk. Moreover, the numerical aperture is mathematically restricted to be less than 1.0. Thus, a further substantial reduction in the size of the mark written onto the optical disk is not currently feasible by conventional methods.

Because of the limitations in reducing the size of the mark, the mark is often larger than the width of a single track in a high density optical disk and, at times, extends over into the adjacent track, thereby resulting in a problem known as adjacent track crosstalk (ATC). ATC is typically a problem when writing low frequency data onto a high-density optical disk (i.e., 8× generation and denser) because the low frequency data typically forms a larger mark. The mark is often larger than an individual track in a high density disk and often extends into the adjacent track, thereby resulting in crosstalk between the two adjacent tracks.

The problems associated with ATC are often also expressed when reading the marks off of the optical disks. More particularly, when reading from a disk, the laser beam commonly analyzes each mark within the track. When ATC exists, the data contained within the larger mark is partially read when the reading process occurs on the adjacent track. Along with the problem of large marks which extend into adjacent tracks is the problem of a large diameter laser beam which reads adjacent tracks or, reads within the track but beyond the diameter of the individual mark. In other words, if the beam diameter were reduced, the beam could read the high frequency smaller marks without reading the larger mark, even if the larger mark extended into the present track.

Therefore, a technique for the reduction in the effective spot size of the laser beam is needed.

### SUMMARY OF THE INVENTION

The present invention includes a method and apparatus for reducing the effective spot size of a laser beam by selectively polarizing different regions of a light beam. By suitably dividing a beam into a plurality of regions and suitably changing the polarization of the regions in different directions, certain regions with opposite polarization cancel each other out, thereby effectively eliminating these regions from analysis by the detector. This region specific polarization is accomplished by known electro-optic devices such as simple phase plates, retarders and/or liquid crystal retarders.

### BRIEF DESCRIPTION OF THE DRAWING FIGURES

The patent or application file contains at least one drawing executed in color. Copies of this patent or patent application publication with color drawing(s) will be provided by the Office upon request and payment of the necessary fee.

In order to facilitate a fuller understanding of the present invention, reference is now made to the appended drawings. These drawings should not be construed as limiting the present invention, but are intended to be examplary only.

FIG. 1 shows a diagram of a basic magneto-optical readout system according to the present invention.

FIG. 2 shows an objective lens bringing a light beam to a focus at the storage layer of a storage medium according to the present invention.

FIG. 3 shows a polarization state of the incident beam at the entrance pupil of the objective according to a first embodiment of the present invention. On the right-hand-side of the aperture, the beam is linearly polarized at +45° to the X-axis; the polarization direction on the left-hand-side is at −45° to the X-axis.

FIG. 4A shows a computed plot-of the total intensity of a focused spot at the focal plane of the objective lens corresponding to the incident beam depicted in FIG. 3.

FIG. 4B shows a computed plot of the log_intensity_{—}3 of a focused spot at the focal plane of the objective lens corresponding to the incident beam depicted in FIG. 3.

FIG. 4C shows a computed plot of the polarization rotation angle ρ of a focused spot at the focal plane of the objective lens corresponding to the incident beam depicted in FIG. 3.

FIG. 4D shows the polarization ellipticity η of a focused spot at the focal plane of the objective lens corresponding to the incident beam depicted in FIG. 3.

FIG. 5A shows a close-up of the focused spot of FIG. 4A.

FIG. 5B shows a close-up of the focused spot of FIG. 4C.

FIG. 5C shows a close-up of the focused spot of FIG. 4D.

FIG. 6A shows the X component of polarization for the focused spot of FIG. 5A.

FIG. 6B shows the Y component of polarization for the focused spot of FIG. 5A.

FIG. 6C shows the Z component of the polarization for the focused spot of FIG. 5A.

FIG. 7 shows a polarization state of the incident beam at the entrance pupil of the objective according to a second embodiment of the present invention.

FIG. 8A shows a computed plot of the total intensity of a focused spot at the focal plane of the objective lens corresponding to the incident beam depicted in FIG. 7.

FIG. 8B shows a computed plot of the polarization rotation angle ρ of a focused spot at the focal plane of the objective lens corresponding to the incident beam depicted in FIG. 7.

FIG. 8C shows a computed plot of the polarization ellipticity η of a focused beam at the focal plane of the objective lens corresponding to the incident beam depicted in FIG. 7.

FIG. 9A shows a plot of the intensity distribution in the focal plane of the objective lens for the X-component of polarization of the incident beam as polarized in FIG. 7.

FIG. 9B shows a plot of the intensity distribution in the focal plane of the objective lens for the Y-component of polarization of the incident beam as polarized in FIG. 7.

FIG. 9C shows a plot of the intensity distribution in the focal plane of the objective lens for the Z-component of polarization of the incident beam as polarized in FIG. 7.

FIG. 10 shows a polarization state of the incident beam at the entrance pupil of the objective according to a third embodiment of the present invention. The aperture is divided into four regions, with opposite regions having mutually orthogonal polarization directions. While region 1 and 3 are polarized along the X- and Y-axes, respectively, the polarization directions of regions 2 and 4 are at ±45° to the X-axis.

FIG. 11A shows a computed plot of the total intensity of a focused spot at the focal plane of the objective lens corresponding to the incident beam depicted in FIG. 10.

FIG. 11B shows a computed plot of the log_intensity_{—}3 at the focal plane of the objective lens depicted in FIG. 10.

FIG. 11C shows a computed plot of the polarization rotation angle ρ depicted in FIG. 10.

FIG. 11D shows the polarization ellipticity η at the focal plane of the optical lens 30 depicted in FIG. 10.

FIG. 12A shows a close-up of the focused spot of FIG. 11A.

FIG. 12B shows a close-up of the focused spot of FIG. 10C.

FIG. 12C shows a close-up of the focused spot of FIG. 10D.

FIG. 13A shows the X component of polarization for the focused spot of FIG. 10.

FIG. 13B shows the Y component of polarization for the focused spot of FIG. 10.

FIG. 13C shows the Z component of the polarization for the focused spot of FIG. 10.

FIG. 14 shows the ellipse of polarization according to the present invention.

FIG. 15 shows a schematic of the focused spot according to another embodiment of the present invention.

FIG. 16 shows a schematic of the focused spot according to another embodiment of the present invention.

### DETAILED DESCRIPTION OF PREFERRED EXEMPLARY EMBODIMENTS

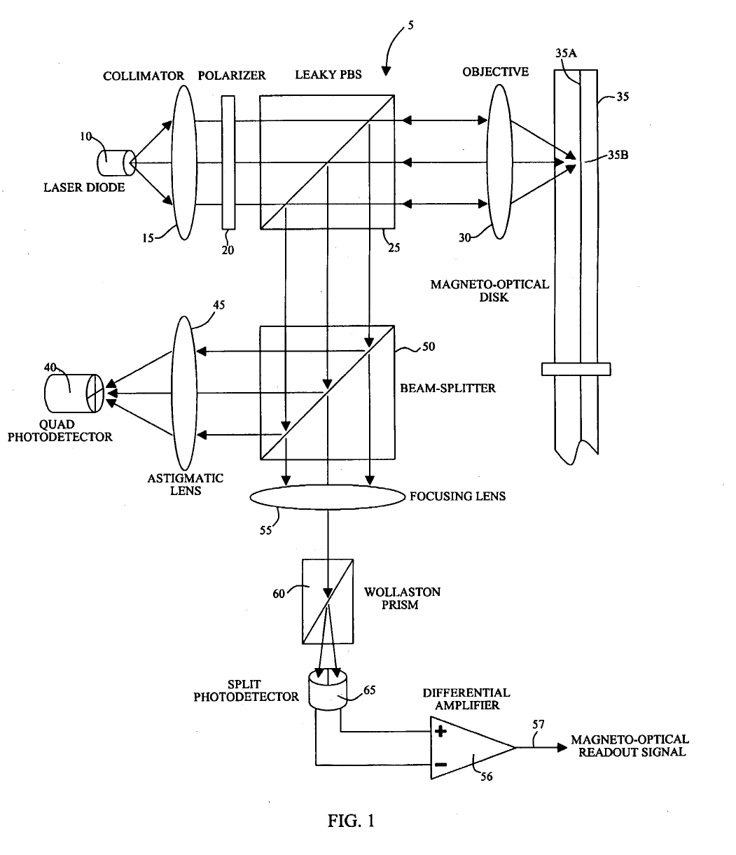

FIG. 1 shows a magneto-optical (MO) readout system 5 according to the present invention. The beam from the laser diode 10, for example a semiconductor laser diode, is collimated by means of the collimator lens 15, and linearly polarized by the polarizer 20.

The laser diode 10 of the present invention emits a coherent, quasi-monochromatic beam of light of a predetermined frequency. If an optical writer, having a numerical aperture of objective lens of about 0.65, uses a normal red laser (wavelength about 650 nm) having an FWHM (Full Width at Half Maximum Intensity) spot size of 600 nm, then the optical reader of the present invention using the same red laser and the same numerical aperture objective lens will be able to read a reduced spot size of about 200 nm. For a 300 nm spot size from blue laser (wavelength about 405 nm) obtained with an objective lens having numerical aperture of objective lens of about 0.85, the present invention can read a reduced spot size of approximately 100 nm.

Polarizer 20 represents any suitable known polarizer capable of polarizing a region of a light beam into a predetermined polarization state such as plane wave polarizer, linear polarizer, circular polarizer and/or the like. For example, in one embodiment, polarizer 20 includes a plane wave polarizer, counter-clockwise (CCW) circular polarizer and clockwise (CW) circular polarizer. While this embodiment includes three polarizers within the polarizer 20, alternatively, any number of polarizers can be used to suitably accomplish the desired polarization strategy. In a further alternative embodiment, polarizer 20 includes any number and arrangement of polarizers, filters, retarders and/or the like capable of polarizing a specific region which are incorporated into one device or arranged as separate devices.

The polarized beam is then transmitted through the leaky polarizing beam-splitter (PBS) 25, and then focused through the aberration-free objective lens 30 onto the magneto-optical layer 35a of the disk 35. The reflected beam is captured by the same objective lens 30, and redirected by the leaky PBS 25 and focused by focusing lens 55 toward a detection module comprising a Wollaston-type prism 60, split photodetector 65, and differential amplifier 56. Although a Wollaston-type prim is shown herein, it should be appreciated that similar polarization separation devices can also be used.

The astigmatic lens 45 (in the servo signal path) creates a focus-error signal from the beam reflected by the beam-splitter 50 that is detected by the quadrant photodetector 40. The same quad detector 40 also produces a push-pull error signal (assuming that the beam is returning from a pre-grooved disk) that is used for automatic track-following. The focus-error and track-error signals, produced by combining the various outputs of the quad-detector 40, are fed back to a pair of voice-coils (not shown) that control the position of the objective lens 30 relative to the spinning disk 35. This feedback system helps maintain the focused spot on-track and in-focus on the magneto-optical layer 35a of the disk 35 at all times during readout.

A fraction of the reflected beam (i.e., that which is reflected from the MO disk and is directed to the detection module by the leaky PBS) passes straight through the beam-splitter 50, goes through a Wollaston-type prism 60, and is split into two beams. These two beams are detected by the split-photodetector 65, whose output is amplified by a differential amplifier 56 to yield the magneto-optical readout signal 57. The imbalance between the output signals from the two separate detectors of the split photodetector 65 is caused by a slight rotation of the polarization vector of the beam at the disk's MO layer 35a. If the disk happens to be non-magnetic, this polarization rotation will not occur, and, consequently, the Wollaston-type prism 60 splits the beam equally between the two halves of the split-detector 65, resulting in a null signal at the output of the differential amplifier. With a magnetic layer perpendicularly magnetized to the disk surface, the sign of the signal at the output of the differential amplifier will depend on the direction of magnetization of the layer, namely, “up-” and “down-” magnetized states of the disk (under the focused laser beam) yield positive or negative readout signals.

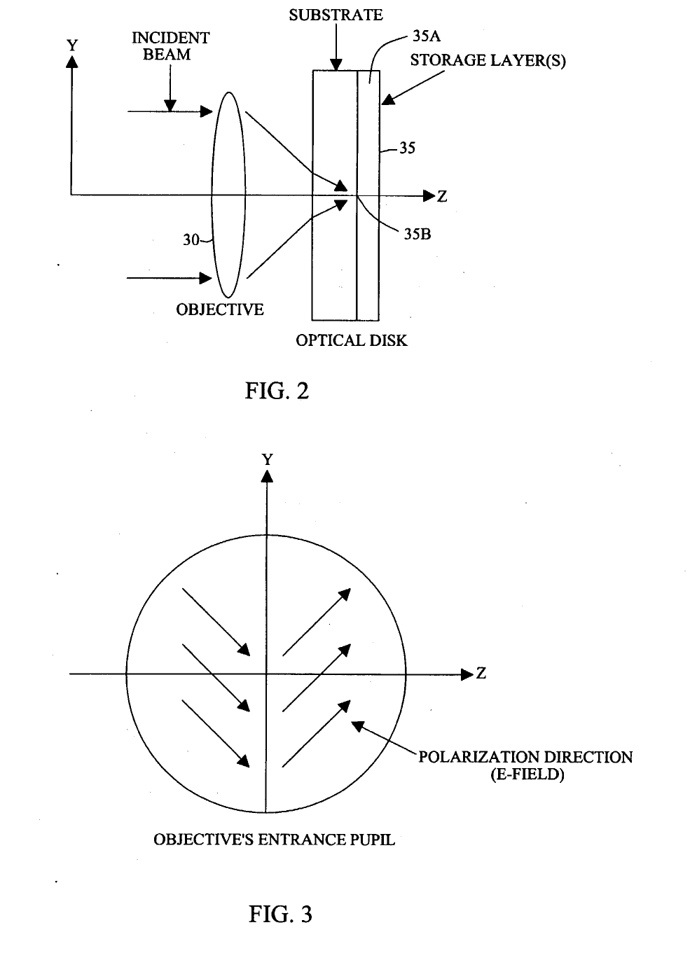

The present invention improves the resolution of readout in a magneto-optical (MO) disk system 5. A coherent, quasi-monochromatic beam of light from a semiconductor laser diode 10 is generally used to probe the local state of magnetization, which contains the recorded information in magneto-optical disks. The collimated beam of light from the laser diode is focused onto the magnetic layer 35a by means of an aberration-free objective lens 30, as shown in FIG. 2.

FIG. 2 shows a truncated Gaussian beam of wavelength λ is incident at the entrance pupil of the objective lens 30. The objective lens 30 has numerical aperture NA and focal length ƒ. The aberration-free objective lens 30 brings the beam to diffraction-limited focus 35b at the storage layer 35a of the optical disk 35. The aberrations caused by focusing through the substrate are assumed to have been corrected by the objective lens 30. FIG. 3 shows a polarization state of the incident beam at the entrance pupil of the objective lens 30. On the right-hand-side of the aperture, the beam is linearly polarized at +45° to the X-axis; the polarization direction on the left-hand-side is at −45° to the X-axis.

The beam of light entering the objective lens 30 is typically polarized in a linear state, in consequence of which the focused spot 35b appearing at the magnetic layer 35a of the disk 35 is also polarized in the same state. A differential detection scheme using split photodetectors 65 is subsequently used to extract the recorded information from the state of polarization of the beam that is reflected from the disk 35 and returned through the objective lens 30.

It so happens that the aforementioned method of differential detection is completely insensitive to the magnetic information recorded on the disk 35 if the focused spot 35b happens to have a circular state of polarization (i.e., either left-circularly-polarized or right-circularly-polarized). In other words, when the focused spot 35b is left- or right-circularly-polarized, the optical signal that returns from the disk is equally split between the two photodetectors 65. Since the final output 57 of the differential amplifier 56 is the algebraic difference between the outputs of these two photodetector signals, equality of the signals from individual detectors means that the final output will be zero, irrespective of whether the magnetization of the disk 35 under the focused spot 35b happens to be “up” or “down.”

The above property of circularly-polarized light in conjunction with the method of differential detection is used herein to improve the resolution of readout in magneto-optical disk drives. This goal is achieved by patterning the state of polarization of the incident beam (e.g., as in FIG. 3) to create a polarization state at the focal plane that is mostly circular. In this way, super-resolution in readout of magnetic domains will be a consequence of the fact that, although the overall size of the focused spot 35b illuminating the magnetic layer 35a will be enlarged (due to the introduction of polarization nonuniformity at the entrance pupil, a form of aberration), the region of the focused spot which is linearly polarized (and therefore capable of producing a detectable signal at the output of the differential detection module) will have become smaller and, therefore, capable of resolving smaller magnetic domains.

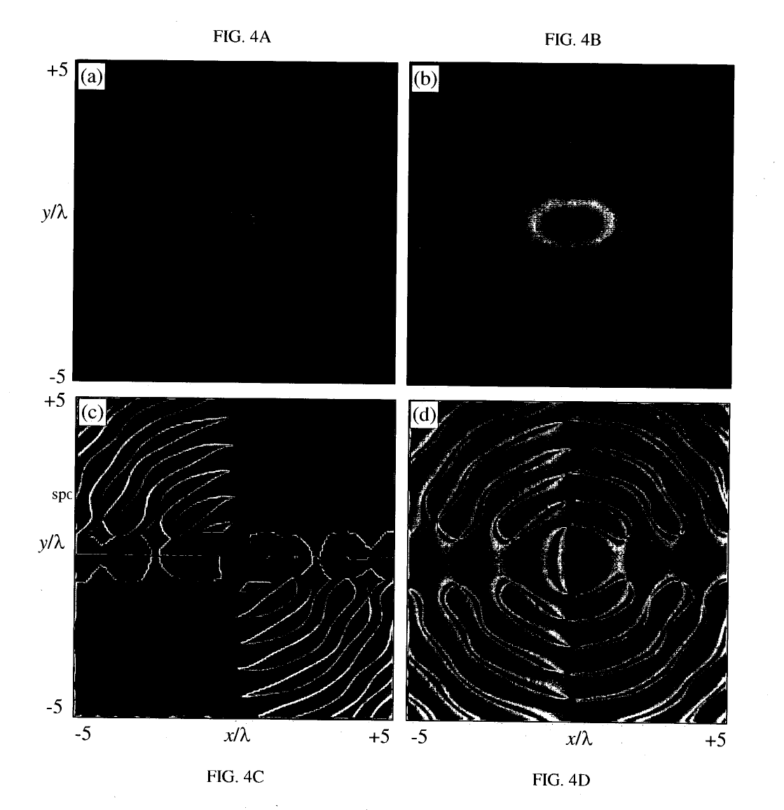

FIGS. 4-13 shows the patterns of intensity and polarization of the focused beam through an objective lens 30 of numerical aperture NA=0.6. The intensity and polarization distributions shown below are plotted in an interval xₘᵢₙ≦x≦xₘₐₓ and yₘᵢₙ≦y≦yₘₐₓ of the X Y-plane by assigning the color red to the maximum value of the function, blue to the minimum value, and the continuum of the white light spectrum to the values in between. For logarithmic plots of intensity, the intensity distribution is first normalized by the peak value of the corresponding function, say, Iₚₑₐₖ=Max (|E|²) within the displayed interval. The base 10 logarithm of the normalized function is then evaluated, and all pixel values below a certain level, say, −α, are set equal to −α. Displayed plots of log_intensity_α thus cover the range from 10^{-α}Iₚₑₐₖ (blue) to Iₚₑₐₖ (red). The polarization rotation angles ρ cover the range from −90° (blue) to +90° (red). When ρ=0° (color green), the major axis of the ellipse of polarization is aligned with the X-axis, whereas ρ=±90° (red or blue) corresponds to an ellipse of polarization whose major axis is along the Y-axis. The polarization ellipticity η covers the range from −45° (blue) to +45° red. When the beam is left-circularly-polarized (LCP) it has η=−45°, whereas a right-circularly-polarized beam (RCP) has η=+45°. The state of linear polarization corresponds to η=0° (green).

FIGS. 4A-D shows computed properties of the focused spot corresponding to the incident beam depicted in FIG. 3. Note that, although the focused spot's intensity profile in FIG. 4A is elongated along the X-axis by a factor of ˜2, the central region of the spot that possesses linear polarization (and is, therefore, cognizant of the magnetization state of the storage layer of the disk) is fairly narrow. It is this narrowing of the linearly-polarized region of the focused spot (compared to the diffraction-limited spot diameter that is achievable with a uniformly polarized beam of light) that is responsible for super-resolution in our proposed scheme.

FIG. 4A shows a computed plot of total intensity at the focal plane of the objective lens 30 depicted in FIG. 2. FIG. 4B shows a computed plot of the log_intensity_{—}3 at the focal plane of the objective lens 30 depicted in FIG. 2. FIG. 4C shows a computed plot of the polarization rotation angle ρ at the focal plane of the objective lens 30 depicted in FIG. 2. FIG. 4D shows the polarization ellipticity η at the focal plane of the objective lens 30 depicted in FIG. 2. The intensity plots in FIG. 4A and FIG. 4B comprise the total electric-field intensity, namely, |Eₓ|²+|E_{y}|²+|E_{z}|². The focused spot is elongated along the X-axis because the discontinuity of the E-field at the entrance pupil of the objective lens is directed along the Y-axis. The logarithmic plot of intensity in FIG. 4B is similar to an over-exposed photograph of the focused spot, showing weak details of the structure of the spot that is not visible in the intensity plot in FIG. 4A. The polarization state of the focused spot is elliptical, with the major axis of the ellipse oriented at an angle ρ relative to the X-axis. The focal-plane distribution of ρ shown in FIG. 4C indicates that at the center of the focused spot, i.e., within the green, elliptical region, the major axis of the ellipse of polarization is parallel to the X-axis. In the same plot, the color red corresponds to ρ=+90°, while the color blue represents ρ=−90°. Thus in the immediate neighborhood of the center, where the focused spot continues to have a significant intensity, the major axis of the ellipse of polarization is parallel (or anti-parallel) to the Y-axis. FIG. 4D shows the degree of polarization ellipticity η in the focal plane of the objective lens 30. The color blue represents the state of left circular polarization (LCP), while the color red corresponds to the state of right-circular polarization (RCP). In between these two extremes lies the state of linear polarization depicted by the color green in FIG. 4D. Note that the central region of the focused spot is linearly polarized along the X-axis (i.e., ρ=0° and η=0°). This narrow region is flanked on the left by an RCP region and on the right by an LCP region. Further out along the X-axis, the polarization state returns to linear (i.e., π=0°); however, in contrast to the central region, the direction of this polarization is now oriented along the Y-axis (i.e., ρ=±90°).

FIGS. 5A, 5B and 5C shows a close-up, respectively, of FIGS. 4A, 4C, and 4D. The distributions of total intensity, polarization rotation angle ρ, and polarization ellipticity η are shown within a 4λ×4λ region at the center of the focal plane. According to the classical theory of diffraction, the diameter of the focused spot produced by an aberration-free lens of numerical aperture NA is 1.22λ/NA (i.e., the Airy disk diameter). In these simulations, NA=0.6 and, therefore, the spot diameter is expected to be around 2λ. This is definitely the case along the Y-axis, as can be readily verified by examining the intensity profile in FIG. 5A. In the horizontal direction, however, the spot diameter is elongated by nearly a factor of two. This is caused by the discontinuity of the polarization state at the entrance pupil of the lens shown in FIG. 3.

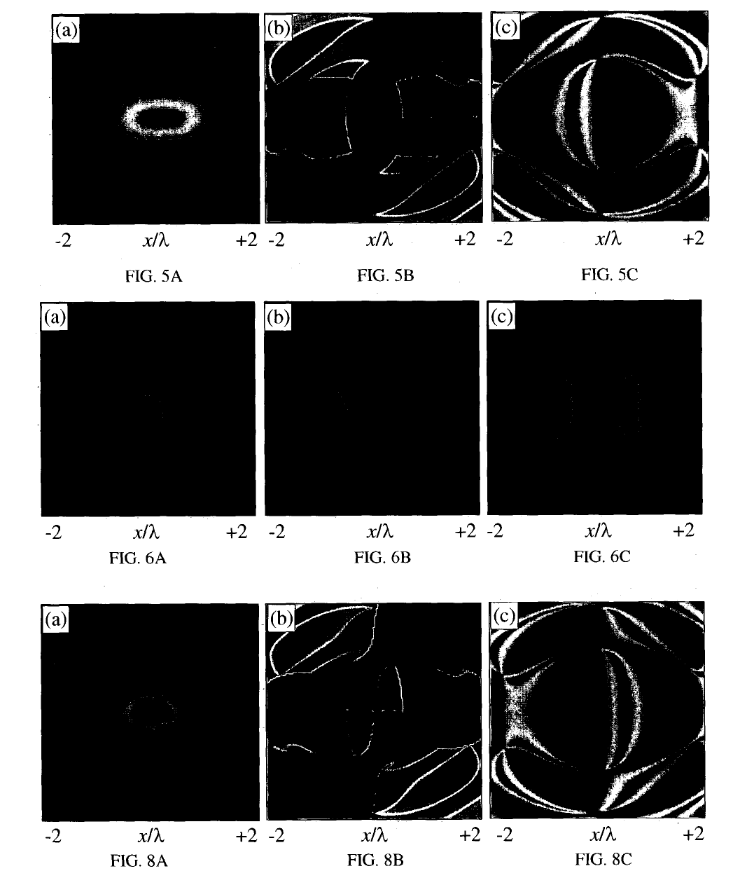

FIGS. 6A-C shows from left to right, plots of intensity distribution in the focal plane of the objective for X-, Y-, and Z-components, respectively, of polarization. The peak intensities are in the ratio of |Eₓ|²:|E_{y}|²:|E_{z}|²=1.00:0.46:0.045. The Z-component of polarization shown in FIG. 6C contains ˜8.4% of the total integrated intensity of the focused spot. The pixel-by-pixel addition of these three plots yields the total intensity profile depicted in FIG. 5A. It is in the gap region between the two lobes of the Y-component in FIG. 5B that the polarization state of the focused spot is linear along the X-axis.

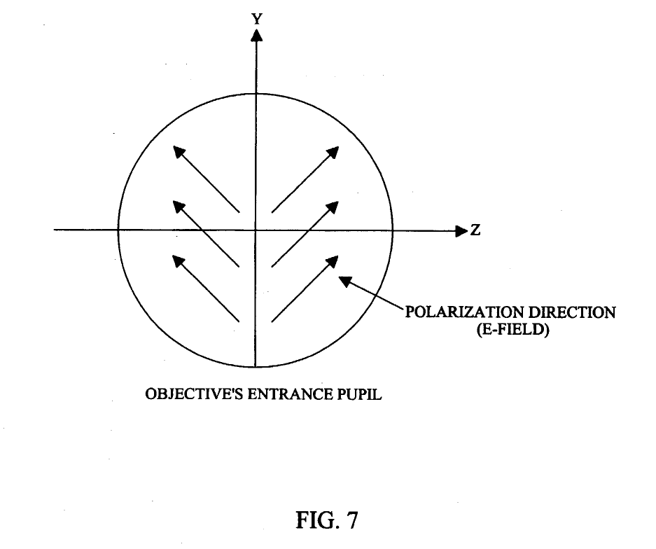

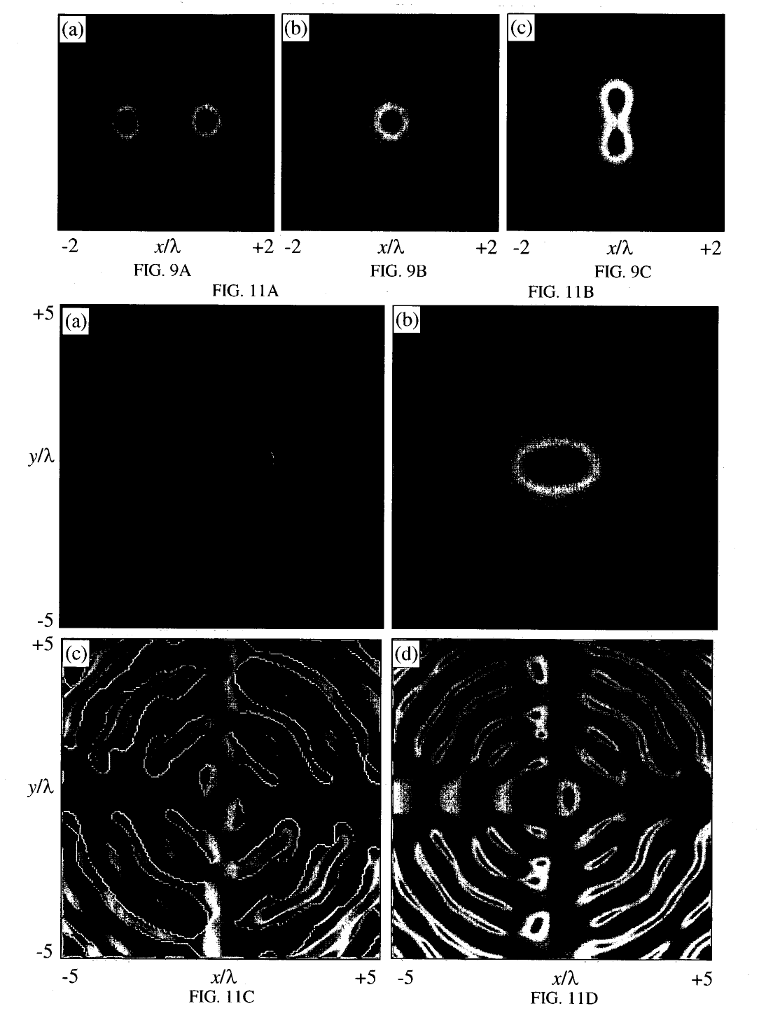

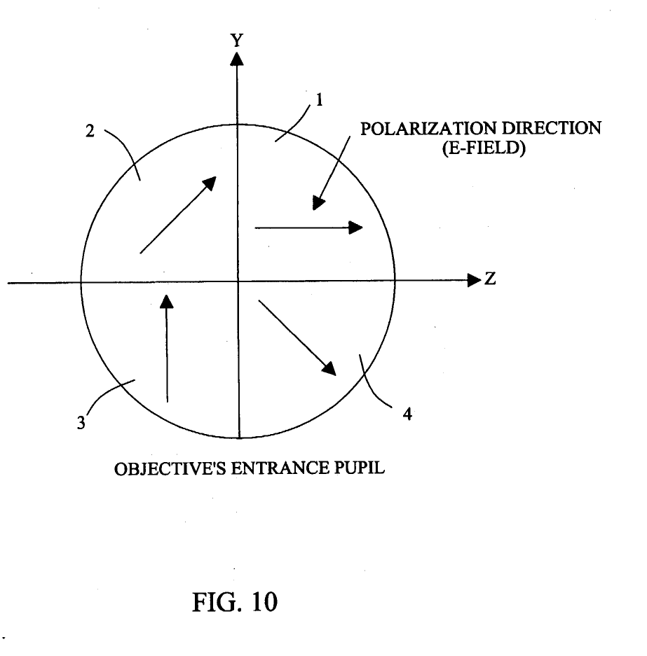

The pattern of polarization of the incident beam that gives rise to such super-resolving behavior is not unique. FIG. 7 shows a slight variation on the same theme, and the corresponding focused spot depicted in FIGS. 8A-C and FIGS. 9A-C is fairly similar to the super-resolving spot of FIGS. 4-6. Similarly, FIG. 10 shows a somewhat more complex pattern of polarization at the entrance pupil of the objective lens. FIGS. 9-11 show the intensity and polarization patterns for the focused beam arising from the polarization distribution depicted in FIG. 8.

FIG. 7 shows a possible pattern of polarization at the entrance pupil of the objective lens 30 of FIG. 2. This is similar to the distribution of FIG. 3, except for the relative phase between the two half-apertures, which is now increased by 180°. Note that the Y-component of polarization is continuous across the aperture, whereas the X-component has a 180° discontinuity in the middle. The corresponding plots of intensity and polarization distribution at the focal plane are shown in FIGS. 8A-C and FIGS. 9A-C.

FIGS. 8A-C shows the focal plane distributions of intensity and polarization state (similar to those in FIGS. 5A-5C) for the incident distribution of FIG. 7. An ellipse-shaped region in the center of the focused spot is now linearly polarized along the Y-axis (i.e., ρ=90°, η=0°). This narrow central region is flanked on the left by an LCP area and, on the right, by an RCP area. Also, the total intensity profile in FIG. 8A seems to be somewhat stronger in the middle compared to that in FIG. 5A.

FIGS. 9A-C shows, from left to right, plots of intensity distribution in the focal plane of the objective for X-, Y-, and Z-components of polarization when the incident beam is polarized as in FIG. 7. The peak intensities are in the ratio of |Eₓ|²:|E_{y}|²:|E_{z}|²=0.45:1.00:0.075. The Z-component of polarization in FIG. 9C contains ˜8.4% of the total integrated intensity of the focused spot. The pixel-by-pixel addition of these three plots yields the total intensity profile depicted in FIG. 6A. It is in the gap region between the two lobes of the X-component in FIG. 6A that the polarization state of the focused spot is linear along the Y-axis.

FIG. 10 shows another possible pattern of polarization at the entrance pupil of the objective lens of FIG. 2. The aperture is now divided into four regions, with opposite regions having mutually orthogonal polarization directions. While regions 1 and 3 are polarized along the X- and Y-axes, respectively, the polarization directions of regions 2 and 4 are at ±45° to the X-axis. Various segmented optical elements such as polarizers, birefringent quarter-wave and half-wave plates, and liquid-crystal cells may be used to produce such patterns of polarization at the entrance pupil. The corresponding plots of intensity and polarization distribution at the focal plane are shown in FIGS. 11A-C, 12A-C, 13A-C.

The proposed scheme applies to reading magneto-optical (MO) media at higher resolution than is feasible with conventional methods. Polarization patterns such as those in FIGS. 3, 7, and 10, may be produced with the aid of active elements (i.e., programmable devices such as segmented liquid crystal cells), in which case only one set of optics (i.e., laser, segmented liquid crystal, lens) is needed, but the polarization pattern is made uniform during writing and non-uniform during readout (with the aid of the programmable active element).

To implement the proposed scheme, one must create a pattern of polarization distribution on the cross-section of the beam prior to entering the objective lens. It is recognized that the same pattern would not appear at the focal plane of the lens, where the beam is focused on the active layer of the disk (i.e., the magneto-optical layer). The physics of light propagation and diffraction is such that the pattern of light (i.e., amplitude, phase, polarization state) that appears at the focal plane is very different from the pattern of light at the entrance pupil of the lens. One must perform a Fourier transform operation on the incident beam's cross-section in order to obtain the pattern of light at the focal plane. Among other things, this means that if the pattern at the focal plane needs to be circularly polarized in some regions, then the pattern at the entrance pupil of the lens may have to be linearly polarized in corresponding regions, and vice versa. The patterns shown in FIGS. 3, 7, and 10 create desired patterns at the focal plane of the objective lens, as do many other patterns that can be obtained by theoretical analysis or by computer simulation.

The improved resolution during readout of the magneto-optical marks will be accompanied by a reduction in the depth of focus of the system, and one must take additional steps to remedy this reduced depth of focus (which has deleterious effects on the focusing servo subsystem).

FIGS. 11A-C are similar to FIGS. 4A-C but corresponding to the incident polarization pattern shown in FIG. 10. Again, a narrow central region of the focused spot is linearly polarized, while the regions to the left and right of the center have circular polarization.

FIGS. 12A-C are the same as FIGS. 5A-C but corresponding to the incident polarization pattern shown in FIG. 10.

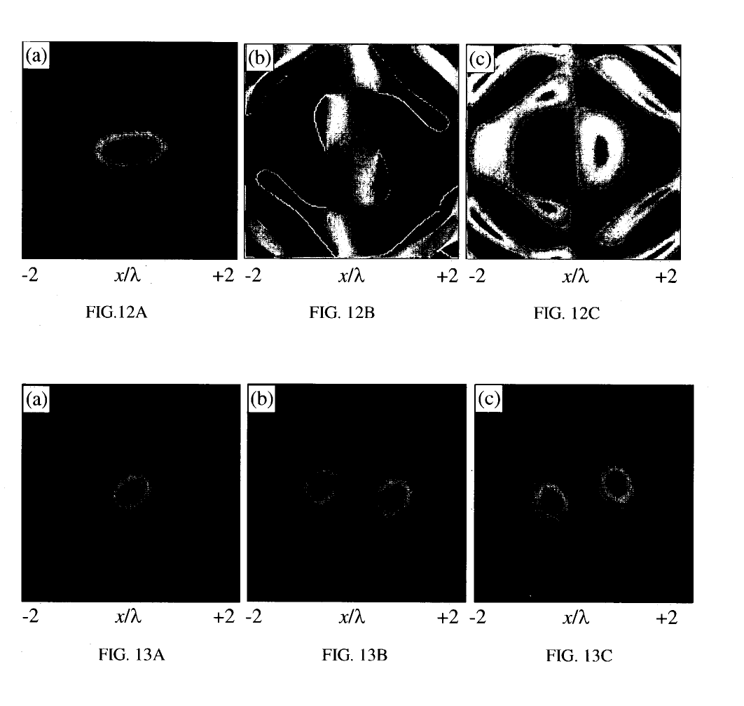

FIGS. 13A-C are the same as FIGS. 6A-C but corresponding to the incident polarization pattern shown in FIG. 10. From left to right, plots of intensity distribution in the focal plane of the 0.6 NA objective for X-, Y-, and Z-components of polarization. The peak intensities are in the ratio of |Eₓ|²:|E_{y}|²:|E_{z}|²=1.00:0.55:0.094. The Z-component of polarization shown in frame (c) contains ˜8.5% of the total integrated intensity of the focused spot. The pixel-by-pixel addition of these three plots yields the total intensity profile depicted in FIG. 12A. It is in the gap region between the two lobes of the Y-component in FIG. 12B that the polarization state of the focused spot is linear along the X-axis.

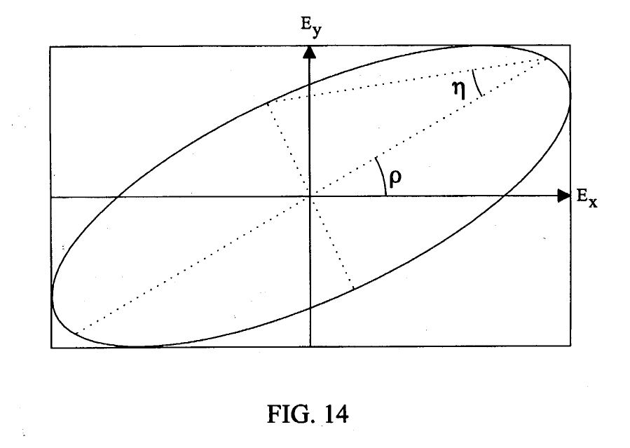

FIG. 14 shows the ellipse of polarization which defines the state of polarization for the light beam of the present invention. Consider a collimated beam of light propagating along the Z-axis. In general, the state of polarization of the beam at any given point is elliptical, as shown in FIG. 16. So long as the electric-field vector E may be assumed to be confined to the XY-plane, it may be resolved into two orthogonal components, say, along the X- and Y-axes. If Eₓ and E_{y} happen to be in phase, the polarization will be linear along some direction specified by the angle ρ. If, on the other hand, the phase difference between Eₓ and E_{y} is ±90°, the polarization will be elliptical, with the major and minor axes of the ellipse lying along the X- and Y-axes. In general, the phase difference between Eₓ and E_{y} is somewhere between 0° and 360°, giving rise to an ellipse whose major axis has an angle ρ with the X-axis, and whose ellipticity is given by the angle η. When the polarization is linear, η=0°; for right-circularly-polarized light (RCP) η=±45°, whereas for left-circularly-polarized light (LCP) η=−45°. In general, −90°<ρ<90° and −45°≦η≦45°.

As shown in FIG. 14, the ellipse of polarization is uniquely specified by Eₓ and E_{y}, the complex-valued electric field components along the X- and Y-axes. The major axis of the ellipse makes an angle ρ with the X-direction, and the angle η facing the minor axis represents polarization ellipticity.

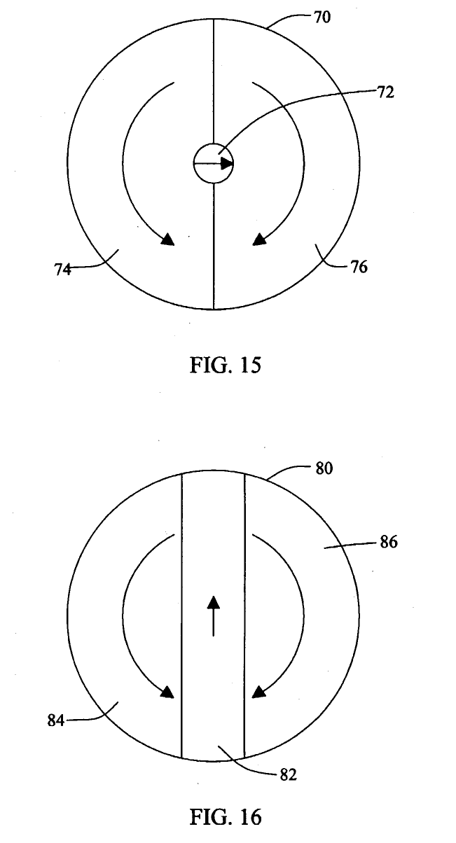

FIGS. 15 and 16 show exemplary schematic beam cross-sections 70, 80 having polarization adjusted regions according to exemplary polarization strategies. By suitably altering the polarization of the regions in different directions, certain regions with opposite polarization suitably effectively cancel each other out. While exemplary embodiments are described below, a person skilled in the art will appreciate that any suitable division and polarization of specific regions can be utilized such that the resulting cancellation of polarization regions provides an effective reduction of spot size 70. More particularly, with respect to FIG. 15, wave plate 20 suitably linearly polarizes a small circular region 72 located at the center of beam 70. Wave plate 20 also circularly polarizes the remaining area (including a substantially “D” shaped side region and a backwards substantially “D” shaped side region) within beam 70 such that substantially equal halves form regions 74, 76 which are oppositely circularly polarized 70. In a preferred embodiment, region 74 is CCW circularly polarized and region 76 is CW circularly polarized. Consequently, regions 74 and 76 effectively cancel each other out leaving only center region 72 as the effective spot.

Alternatively, with respect to FIG. 16, polarizer 20 suitably linearly polarizes center strip region 82. Polarizer 20 also suitably circularly polarizes the remaining area within spot 80 (including a substantially “D” shaped side region and a backwards substantially “D” shaped side region) such that substantially equal side areas form regions 84, 86 which are oppositely circularly polarized. In this alternative embodiment, region 84 is CCW circularly polarized and region 86 is CW circularly polarized. Consequently, regions 84 and 86 effectively cancel each other out leaving only center strip 82 as the effective beam.

While the present invention has been described in conjunction with preferred and alternate embodiments set forth in the drawing figures and the specification, it will be appreciated that the invention is not so limited. For example, the method and apparatus for reducing the effective beam size is not limited to effective reduction of the beam size for optical readers, but can be used for any application which requires a smaller effective beam size. Moreover, other sizes, shapes, materials and shading band devices can be incorporated into the reading devices. Various modifications in the selection and arrangement of components and materials may be made without departing from the spirit and scope of the invention as set forth in the appended claims.

1. An apparatus for creating a reduced effective spot size, comprising:
an objective lens;
a light beam incident at the entrance to said objective lens comprising a polarization pattern comprising first regions; and
a storage medium configured so that said objective lens brings said light beam to a focus to form a spot comprising second regions at said storage medium.

2. The apparatus of claim 1, wherein said first regions have different modes of polarization.

3. The apparatus of claim 1, wherein said second regions have different modes of polarization.

4. The apparatus of claim 1, further comprising an optical element configured to create said polarization pattern.

5. The apparatus of claim 4, wherein said optical element comprises a polarizer.

6. The apparatus of claim 4, wherein said optical element comprises a quarter-wave plate.

7. The apparatus of claim 4, wherein said optical element comprises a half-wave plate.

8. The apparatus of claim 4, wherein said optical element comprises liquid-crystal cells.

9. The apparatus of claim 1, wherein said spot comprises a linearly polarized center region as one of said second regions.

10. The apparatus of claim 1, wherein said spot comprises a linearly polarized center region of said second regions and an outer region comprises a left circular polarized region of said second regions and a right circular polarized region of said second regions.

11. The apparatus of claim 1 wherein said second regions include a substantially “D” shaped side region having substantially clockwise polarization, a backwards substantially “D” shaped side region having substantially counterclockwise polarization and a substantially circular central region having substantially linear polarization.

12. The apparatus of claim 1 wherein said second regions include a substantially “D” shaped side region having substantially clockwise polarization. a backwards substantially “D” shaped side region having substantially counterclockwise polarization and a substantially rectangular central region having substantially linear polarization.

13. The apparatus of claim 1, wherein said polarization pattern comprises said first regions comprising a right-hand side region polarized at about +45 degrees to an X-axis and a left-hand side region polarized at about 45 degrees to said X-axis.

14. The apparatus of claim 1, wherein said polarization pattern comprises said first regions comprising an incident light beam at the entrance pupil to said objective lens comprising a polarization state comprising a region which is right-hand side polarized at +45 degrees to an X-axis and a region which is left-hand side at −135 degrees to said X-axis

15. The apparatus of claim 1, wherein an incident light beam at the entrance pupil to said objective lens comprises said first regions comprising a first quadrant, a second quadrant, a third quadrant, and a fourth quadrant with opposite quadrants having mutually orthogonal polarizations.

16. The apparatus of claim 1 is a magneto-optical readout system.

17. The apparatus of claim 1 wherein said storage medium comprises a magneto-optical disk.

18. The apparatus of claim 1, further comprises a differential detector for receiving a reflected component of said spot.

19. The apparatus of claim 18, wherein said differential detector further comprises:
a split photodetector configured to receive said reflected component of said spot and convert said reflected component to a first electrical signal and a second electrical signal; and
a differential amplifier configured to generate from said first and-second electrical signals a readout signal indicating the binary state of said storage medium under said light beam.

20. The apparatus of claim 1, wherein said light beam is a coherent, quasi-monochromatic beam of light from a semiconductor laser diode.

21. A method for creating a reduced spot size, comprising the steps of focusing a light beam comprising a polarization pattern comprising first regions to a storage medium to form a spot comprising second regions at said storage medium.

22. The method of claim 21, further comprising the step of polarizing said light beam to create said polarization pattern comprising said first regions.

23. The method of claim 21, wherein said first regions have different modes of polarization.

24. The method of claim 21, wherein said second regions have different modes of polarization.

25. The method of claim 21, further comprising an optical element configured to create said polarization pattern.

26. The method of claim 25, wherein said optical element comprises a polarizer.

27. The method of claim 25, wherein said optical element comprises a quarter-wave plate.

28. The method of claim 25, wherein said optical element comprises a half-wave plate.

29. The method of claim 25, wherein said optical element comprises liquid-crystal cells.

30. The method of claim 21, wherein said spot comprises a linearly polarized center region as one of said second regions.

31. The method of claim 21, wherein said spot comprises a linearly polarized center region of said second regions and an outer region comprises a left circular polarized region of said second regions and a right circular polarized region of said second regions.

32. The method of claim 21 wherein said second regions include a substantially “D” shaped side region having substantially clockwise polarization, a backwards substantially “D” shaped side region having substantially counterclockwise polarization and a substantially circular central region having substantially linear polarization.

33. The method of claim 21 wherein said second regions include a substantially “D” shaped side region having substantially clockwise polarization. a backwards substantially “D” shaped side region having substantially counterclockwise polarization and a substantially rectangular central region having substantially linear polarization.

34. The method of claim 21, wherein said polarization pattern comprises said first regions comprising a right-hand side region polarized at about +45 degrees to an X-axis and a left-hand side region polarized at about 45 degrees to said X-axis.

35. The method of claim 21, wherein said polarization pattern comprises said first regions comprising an incident light beam at the entrance pupil to said objective lens comprising a polarization state comprising a region which is right-hand side polarized at about +45 degrees to an X-axis and a region which is left-hand side at about −135 degrees to said X-axis

36. The method of claim 21, wherein an incident light beam at the entrance pupil to said objective lens comprises said first regions comprising a first quadrant, a second quadrant, a third quadrant, and a fourth quadrant with opposite quadrants having mutually orthogonal polarizations.

37. The method of claim 21 is a magneto-optical readout system.

38. The method of claim 21 wherein said storage medium comprises a magneto-optical disk.

39. The method of claim 21, further comprising the step of differential detecting a reflected component of said spot.

40. The method of claim 21, further comprising the step of:
differentially converting a reflected component of said spot to a first electrical signal and a second electrical signal; and
generating from said first and second electrical signals a readout signal indicating the binary state of said storage medium under said light beam.

41. The method of claim 21, wherein said light beam is a coherent, quasi-monochromatic beam of light from a semiconductor laser diode.
